(19) United States
(12) Patent Application Publication
(10) Pub. No.: US 2024/0204367 A1
(43) Pub. Date: Jun. 20, 2024

(54) BUS BAR RETENTION SYSTEMS FOR TRACTION BATTERY PACKS

(71) Applicant: FORD GLOBAL TECHNOLOGIES, LLC, Dearborn, MI (US)

(72) Inventors: Ryan Scott GRAY, Farmington Hills, MI (US); Alexander Robert RINK, Royal Oak, MI (US); Dominic Mario BERTOLINI, Royal Oak, MI (US); Michael BARR, Canton, MI (US); Eid FARHA, Ypsilanti, MI (US); Parikshit GUPTE, West Bloomfield, MI (US)

(21) Appl. No.: 18/067,959

(22) Filed: Dec. 19, 2022

(51) Int. Cl. H01M 50/517; H01M 10/658; H01M 50/593

(52) U.S. Cl. CPC H01M 50/517; H01M 10/658; H01M 50/593; H01M 2220/20

(57) ABSTRACT

Retention systems are provided for positioning and retaining bus bars relative to battery array terminals within a traction battery pack. The retention systems may include features for urging a bus bar into contact with an array terminal of a battery system. The retention systems may additionally incorporate features for preventing exposure to high voltage areas of the battery system and for directing vent gases toward pack-level venting systems. In some implementations, the bus bar retention features are provided by a combination of a thermal barrier structure and a terminal clip of the retention system.

### TECHNICAL FIELD

This disclosure relates generally to electrified vehicle traction battery packs, and more particularly to retention systems for positioning and retaining bus bars relative to battery array terminals of a traction battery pack battery system.

### BACKGROUND

A high voltage traction battery pack typically powers the electric machines and other electrical loads of an electrified vehicle. The traction battery pack includes a plurality of battery cells and various other battery internal components that must be reliably connected for supporting the electric propulsion of the vehicle.

### SUMMARY

A traction battery pack according to an exemplary aspect of the present disclosure includes, among other things, a battery array including an array terminal, a bus bar positioned in abutting contact with the array terminal, and a bus bar retention system arranged to horizontally and vertically position the bus bar relative to the array terminal.

In a further non-limiting embodiment of the foregoing traction battery pack, the bus bar retention system includes a terminal clip and an extension of a hood, the terminal clip being configured to horizontally position the bus bar and the extension being configured to vertically position the bus bar.

In a further non-limiting embodiment of either of the foregoing traction battery packs, the hood is an integral component of a thermal barrier structure arranged between the battery array and a second battery array.

In a further non-limiting embodiment of any of the foregoing traction battery packs, the bus bar retention system includes a protruding prong of an insulation cover that at least partially surrounds the array terminal, and an extension of a hood that extends over top of the array terminal.

In a further non-limiting embodiment of any of the foregoing traction battery packs, the protruding prong is configured to horizontally position the bus bar and the extension is configured to vertically position the bus bar.

In a further non-limiting embodiment of any of the foregoing traction battery packs, an extension of a hood of a thermal barrier structure of the bus bar retention system vertically positions the bus bar relative to the array terminal.

In a further non-limiting embodiment of any of the foregoing traction battery packs, a deflector extends from the extension to a position that is laterally outward from the bus bar.

In a further non-limiting embodiment of any of the foregoing traction battery packs, the bus bar retention system includes a terminal clip that horizontally positions the bus bar relative to the array terminal.

In a further non-limiting embodiment of any of the foregoing traction battery packs, the terminal clip includes a vertical portion positioned in contact with the bus bar and a horizontal portion positioned in contact with the array terminal.

In a further non-limiting embodiment of any of the foregoing traction battery packs, the bus bar retention system includes an insulation cover that at least partially surrounds the array terminal and is configured to horizontally position the bus bar relative to the array terminal.

A traction battery pack according to another exemplary aspect of the present disclosure includes, among other things, a first battery array including a first array terminal, a second battery array including a second array terminal, a bus bar configured to electrically connect the first battery array and the second battery array, and a thermal barrier structure arranged between the first battery array and the second battery array. The thermal barrier structure includes a hood having an extension that extends over top of the first array terminal or the second array terminal. The extension vertically positions the bus bar relative to the first array terminal or the second array terminal.

In a further non-limiting embodiment of the foregoing traction battery pack, a terminal clip horizontally positions the bus bar in abutting contact with the first array terminal or the second array terminal.

In a further non-limiting embodiment of either of the foregoing traction battery packs, the terminal clip includes a protruding nub that urges the bus bar into abutting contact with the first array terminal or the second array terminal.

In a further non-limiting embodiment of any of the foregoing traction battery packs, the bus bar is sandwiched between the terminal clip and the first array terminal or the second array terminal.

In a further non-limiting embodiment of any of the foregoing traction battery packs, a protruding prong is positioned on an opposite side of the terminal clip from the bus bar.

In a further non-limiting embodiment of any of the foregoing traction battery packs, the protruding prong is part of an insulation cover that at least partially surrounds the first array terminal or the second array terminal.

In a further non-limiting embodiment of any of the foregoing traction battery packs, a protruding prong is arranged to horizontally position the bus bar in abutting contact with the first array terminal or the second array terminal.

In a further non-limiting embodiment of any of the foregoing traction battery packs, the protruding prong is part of an insulation cover that at least partially surrounds the first array terminal or the second array terminal.

In a further non-limiting embodiment of any of the foregoing traction battery packs, the extension urges the bus bar into abutting contact with a terminal clip that is connected to the first array terminal or the second array terminal.

In a further non-limiting embodiment of any of the foregoing traction battery packs, the extension urges the bus bar into abutting contact with a protruding prong of an insulation cover that at least partially surrounds the first array terminal or the second array terminal.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle that includes a traction battery pack.

FIG. 2 illustrates select portions of a battery system of a traction battery pack.

FIG. 3 is a cross-sectional view through section 3-3 of FIG. 2 and illustrates features of a bus bar retention system of the battery system.

FIG. 4 illustrates another exemplary bus bar retention system for a traction battery pack.

FIG. 5 illustrates yet another exemplary bus bar retention system for a traction battery pack.

### DETAILED DESCRIPTION

This disclosure details retention systems for positioning and retaining bus bars relative to battery array terminals within a traction battery pack. The retention systems may include features for urging a bus bar into contact with an array terminal of a battery system. The retention systems may additionally incorporate features for preventing exposure to high voltage areas of the battery system and for directing vent gases toward pack-level venting systems. In some implementations, the bus bar retention features are provided by a combination of a thermal barrier structure and a terminal clip of the retention system. These and other features are discussed in greater detail in the following paragraphs of this detailed description.

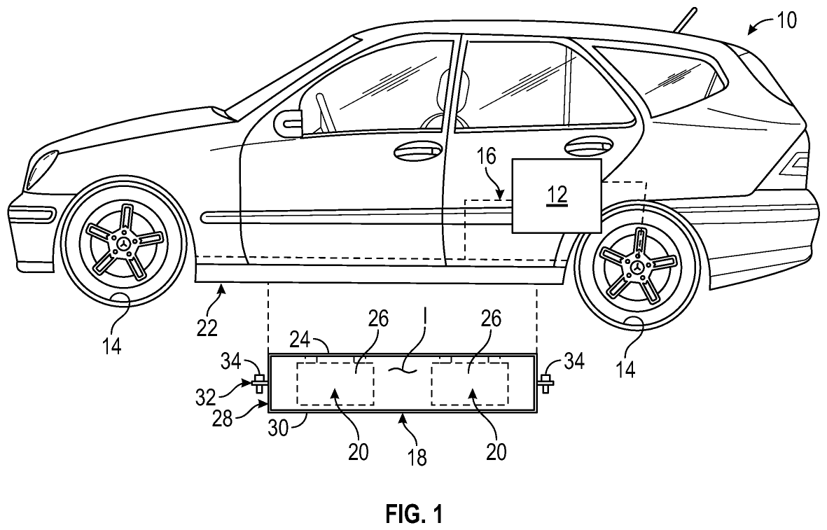

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In the illustrated embodiment, the electrified vehicle 10 is a sport utility vehicle (SUV). However, the electrified vehicle 10 could alternatively be a car, a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes one or more battery arrays 20 (i.e., battery assemblies or groupings of rechargeable battery cells 26) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 26 may be stacked side-by-side along a stack axis to construct a grouping of battery cells 26, sometimes referred to as a “cell stack.” In the highly schematic depiction of FIG. 1, the battery cells 26 are stacked in a direction into the page to construct each battery array 20, and thus the battery arrays 20 extend in cross-car direction. However, other configurations may also be possible.

The total number of battery arrays 20 and battery cells 26 provided within the traction battery pack 18 is not intended to limit this disclosure. In an embodiment, the battery cells 26 of each battery array 20 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The traction battery pack 18 may be secured to an underbody 22 of the electrified vehicle 10. However, the traction battery pack 18 could be located elsewhere on the electrified vehicle 10 within the scope of this disclosure.

An outer enclosure assembly 28 may house each battery array 20 of the traction battery pack 18. The outer enclosure assembly 28 may be a sealed enclosure and may embody any size, shape, and configuration within the scope of this disclosure. In an embodiment, the outer enclosure assembly 28 includes an enclosure cover 24 and an enclosure tray 30. Together, the enclosure cover 24 and the enclosure tray 30 may establish an interior I for housing the battery arrays 20 and other battery internal components (e.g., bussed electrical center, battery electric control module, wiring, coolant lines, connectors, etc.) of the traction battery pack 18.

During assembly of the traction battery pack 18, the enclosure cover 24 may be secured to the enclosure tray 30 at an interface 32 therebetween. The interface 32 may substantially circumscribe the interior I. In some implementations, mechanical fasteners 34 may be used to secure the enclosure cover 24 to the enclosure tray 30, although other fastening methodologies (adhesion, etc.) could also be suitable.

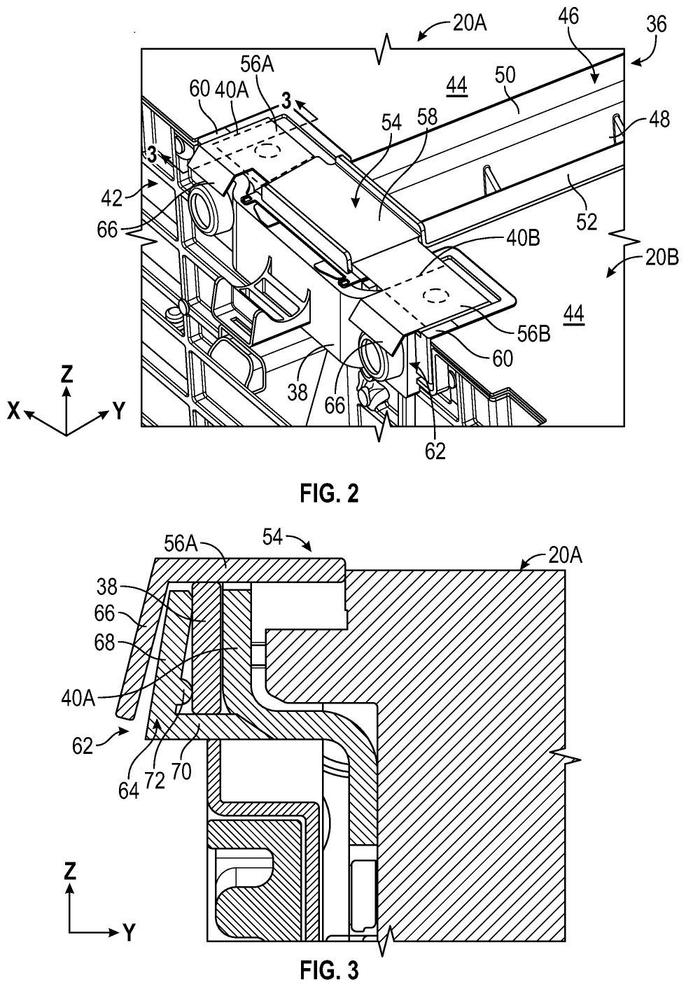

FIG. 2 illustrates an exemplary battery system 36 for a traction battery pack, such as the traction battery pack 18 of FIG. 1, for example. The battery system 36 may include a first battery array 20A, a second battery array 20B, and one or more bus bars 38 for electrically connecting the first and second battery arrays 20A, 20B. Although two battery arrays and one bus bar are shown as part of the battery system 36 of FIG. 2, the battery system 36 could include a greater number of battery arrays and bus bars within the scope of this disclosure.

The bus bar 38 may connect the first and second battery arrays 20A, 20B in either a series string configuration or a parallel string configuration. In an embodiment, the bus bar 38 is connected to each of a first array terminal 40A of the first battery array 20A and a second array terminal 40B of the second battery array 20B for electrically connecting the first and second battery arrays 20A, 20B. The array terminals 40A, 40B may be high voltage terminals. The second array terminal 40B may have the same polarity (e.g., for a parallel string configuration) or a different polarity (e.g., for a series string configuration) as the first array terminal 40A. An insulation cover 60 may be arranged about each of the array terminals 40A, 40B for insulating each respective terminal.

In an embodiment, the bus bar 38 is mounted relative to an end wall 42 as opposed to an upper surface 44 of each of the first battery array 20A and the second battery array 20B. The bus bar 38 is therefore positioned at the longitudinal extent of each battery array 20A, 20B and does not contribute to a vertical (e.g., Z-axis) footprint of the battery system 36.

A thermal barrier structure 46 may be disposed axially between the first battery array 20A and the second battery array 20B. The thermal barrier structure 46 may be positioned within a gap that extends between the first and second battery arrays 20A, 20B and may be configured to establish a thermal barrier therebetween. In an embodiment, the thermal barrier structure 46 is a plastic component of the battery system 36.

The thermal barrier structure 46 may include a base 48, a first flange 50, and a second flange 52. The base 48 may be positioned within the gap between the first and second battery arrays 20A, 20B and may be mounted to a structural cross member (not shown) of the traction battery pack 18. The first flange 50 and the second flange 52 may extend from opposite sides of the base 48. The first flange 50 may extend over top of the upper surface 44 of the first battery array 20A, and the second flange 52 may extend over top of the upper surface 44 of the second battery array 20B. The first flange 50 and the second flange 52 may exert a clamping load against the first and second battery arrays 20A, 20B.

The thermal barrier structure 46 may additionally include a hood 54 arranged to cover portions of the first array terminal 40A, the second array terminal 40B, and the bus bar 38. The hood 54 may include extensions 56A, 56B that are separated by a bridge 58. The extension 56A may project outwardly in a first direction from the bridge 58 for covering portions of the first array terminal 40A and a first end portion of the bus bar 38, and the extension 56B may project outwardly in a second direction from the bridge 58 for covering portions of the second array terminal 40B and a second end portion of the bus bar 38.

Referring now to FIGS. 2 and 3, a retention system 62 may be provided for positioning and retaining the bus bar 38 both vertically (e.g., along a Z-axis) and horizontally (e.g., along an X-axis) relative to the array terminals 40A, 40B without using mechanical fasteners. As further discussed below, the retention system 62 may be established by a combination of portions of the hood 54 of the thermal barrier structure 46 and a terminal clip 64 that is arranged relative to the bus bar 38. Notably, the terminal clip 64 is removed in FIG. 2 in order to better illustrate the arrangement of the bus bar 38. Further, although only illustrated with respect to the first battery array 20A in FIG. 3, the retention system 62 provides similar features for retaining the bus bar 38 relative to the array terminal 40B of the second battery array 20B.

The extension 56A of the hood 54 of the thermal barrier structure 46 may extend over top of the bus bar 38. The extension 56A therefore functions to position and retain (e.g., hold down) the bus bar 38 vertically along the Z-axis relative to the first array terminal 40A of the first battery array 20A. The extension 56A may urge the bus bar 38 into contact with a horizontal portion 70 of the terminal clip 64.

A deflector 66 may extend from the extension 56A in a laterally outward direction from the bus bar 38. The deflector 66 may extend at an angle relative to the extension 56A. Together, the deflector 66 and the extension 56A may prevent finger access to the bus bar 38. The deflector 66 and the extension 56A may therefore provide “finger-proof” features for preventing inadvertent exposure to high voltage areas of the battery system 36. The deflector 66 may further function to direct vent gases expelled by the battery system 36 toward a venting system (not shown) of the traction battery pack 18.

The terminal clip 64 may include a vertical portion 68 and the horizontal portion 70. The vertical portion 68 may urge the bus bar 38 into abutting contact with the first array terminal 40A. The vertical portion 68 may be arranged to hold the bus bar 38 horizontally along the X-axis against the first array terminal 40A. The bus bar 38 may sandwiched between the terminal clip 64 and the first array terminal 40A. The vertical portion 68 may include a protruding nub 72 for ensuring adequate contact between the bus bar 38 and the first array terminal 40A.

The horizontal portion 70 of the terminal clip 64 may extend from the vertical portion 68 in a direction toward the first array terminal 40A. The horizontal portion 70 may be fixedly secured to the first array terminal 40A. In an embodiment in which the terminal clip 64 is a metallic component, the horizontal portion 70 may be welded to the first array terminal 40A. In another embodiment in which the terminal clip 64 is a plastic component, the terminal clip 64 may be fixed in place relative to the first array terminal 40A using an interference fit.

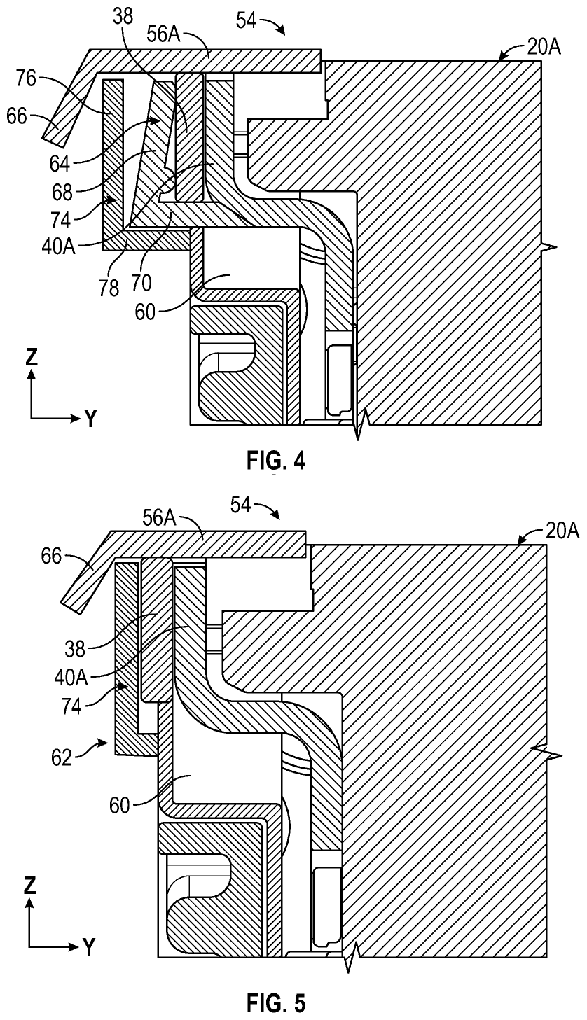

In a further embodiment, shown in FIG. 4, the insulation cover 60 may include a protruding prong 74 that shields portions of the terminal clip 64, the bus bar 38, and/or the first array terminal 40A. The protruding prong 74 of the insulation cover 60 may be an additional component of the retention system 62 that contributes to preventing inadvertent exposure to high voltage areas of the battery system 36.

The protruding prong 74 may include a vertical portion 76 that interfaces with the vertical portion 68 of the terminal clip 64, and a horizontal portion 78 that interfaces with the horizontal portion 70 of the terminal clip 64. The horizontal portion 78 of the protruding prong 74 may be integrally connected to a main body of the insulation cover 60.

In yet another embodiment, shown in FIG. 5, the protruding prong 74 of the insulation cover 60 may be incorporated into the retention system 62 in place of the terminal clip 64. In such an implementation, the protruding prong 74 may be arranged to hold the bus bar 38 horizontally against the array terminal 40A. The bus bar 38 may therefore be sandwiched between the protruding prong 74 and the first array terminal 40A.

The exemplary bus bar retention systems of this disclosure are designed for bussing battery arrays without requiring the use of mechanical fasteners for securing the bus bars in place. Bus bar attachment can therefore be more readily automated, thereby minimizing manufacturing complexities and reducing the number of required assembly steps.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery array including an array terminal;
a bus bar positioned in abutting contact with the array terminal; and
a bus bar retention system arranged to horizontally and vertically position the bus bar relative to the array terminal.

2. The traction battery pack as recited in claim 1, wherein the bus bar retention system includes a terminal clip and an extension of a hood, the terminal clip being configured to horizontally position the bus bar and the extension being configured to vertically position the bus bar.

3. The traction battery pack as recited in claim 2, wherein the hood is an integral component of a thermal barrier structure arranged between the battery array and a second battery array.

4. The traction battery pack as recited in claim 1, wherein the bus bar retention system includes a protruding prong of an insulation cover that at least partially surrounds the array terminal and an extension of a hood that extends over top of the array terminal.

5. The traction battery pack as recited in claim 4, wherein the protruding prong is configured to horizontally position the bus bar and the extension is configured to vertically position the bus bar.

6. The traction battery pack as recited in claim 1, wherein an extension of a hood of a thermal barrier structure of the bus bar retention system vertically positions the bus bar relative to the array terminal.

7. The traction battery pack as recited in claim 6, comprising a deflector that extends from the extension to a position that is laterally outward from the bus bar.

8. The traction battery pack as recited in claim 1, wherein the bus bar retention system includes a terminal clip that horizontally positions the bus bar relative to the array terminal.

9. The traction battery pack as recited in claim 8, wherein the terminal clip includes a vertical portion positioned in contact with the bus bar and a horizontal portion positioned in contact with the array terminal.

10. The traction battery pack as recited in claim 1, wherein the bus bar retention system includes an insulation cover that at least partially surrounds the array terminal and is configured to horizontally position the bus bar relative to the array terminal.

11. A traction battery pack, comprising:
a first battery array including a first array terminal;
a second battery array including a second array terminal;
a bus bar configured to electrically connect the first battery array and the second battery array; and
a thermal barrier structure arranged between the first battery array and the second battery array,
wherein the thermal barrier structure includes a hood having an extension that extends over top of the first array terminal or the second array terminal,
wherein the extension vertically positions the bus bar relative to the first array terminal or the second array terminal.

12. The traction battery pack as recited in claim 11, comprising a terminal clip that horizontally positions the bus bar in abutting contact with the first array terminal or the second array terminal.

13. The traction battery pack as recited in claim 12, wherein the terminal clip includes a protruding nub that urges the bus bar into abutting contact with the first array terminal or the second array terminal.

14. The traction battery pack as recited in claim 12, wherein the bus bar is sandwiched between the terminal clip and the first array terminal or the second array terminal.

15. The traction battery pack as recited in claim 12, comprising a protruding prong positioned on an opposite side of the terminal clip from the bus bar.

16. The traction battery pack as recited in claim 15, wherein the protruding prong is part of an insulation cover that at least partially surrounds the first array terminal or the second array terminal.

17. The traction battery pack as recited in claim 11, comprising a protruding prong arranged to horizontally position the bus bar in abutting contact with the first array terminal or the second array terminal.

18. The traction battery pack as recited in claim 17, wherein the protruding prong is part of an insulation cover that at least partially surrounds the first array terminal or the second array terminal.

19. The traction battery pack as recited in claim 11, wherein the extension urges the bus bar into abutting contact with a terminal clip that is connected to the first array terminal or the second array terminal.

20. The traction battery pack as recited in claim 11, wherein the extension urges the bus bar into abutting contact with a protruding prong of an insulation cover that at least partially surrounds the first array terminal or the second array terminal.
